(19) United States
(12) Patent Application Publication
(10) Pub. No.: US 2013/0083409 A1
(43) Pub. Date: Apr. 4, 2013

(54) Voice Coil Motor

(71) Applicant: Sanghee Lee, Seoul (KR)

(72) Inventor: Sanghee Lee, Seoul (KR)

(73) Assignee: LG Innotek Co., Ltd., Seoul (KR)

(21) Appl. No.: 13/555,694

(22) Filed: Jul. 23, 2012

(30) Foreign Application Priority Data
Sep. 29, 2011 (KR) 10-2011-0098861

(51) Int. Cl. G02B 7/04

(52) U.S. Cl. 359/824

(57) ABSTRACT

Disclosed is a voice coil motor, the motor including a base having an opening, a foreign-substance trapping film provided on an upper surface of the base to trap foreign substances, a mover disposed on the base and including a bobbin supporting a lens and a coil block provided on an outer circumference of the bobbin, a stator supported on the base and having a magnet disposed to face the coil block, and an elastic member connected to the mover and the base to elastically support the mover, wherein a receiving portion is formed on the upper surface of the base along a boundary of the foreign-substance trapping film.

### CROSS-REFERENCE TO RELATED APPLICATION

This application claims the benefit under 35 U.S.C. §119 of Korean Patent Application No. 10-2011-0098861, filed Sep. 29, 2011, which is hereby incorporated by reference in its entirety.

### BACKGROUND

1. Field of the Invention

The present invention relates to a voice coil motor.

2. Description of the Related Art

Recently, a variety of portable electronic devices, such as a mobile phone equipped with a micro digital camera, are being developed.

The micro digital camera mounted on the mobile phone largely includes an image sensor converting external light to a digital image, and an optical lens arranged to face the image sensor. It is difficult for the conventional micro digital camera to adjust a distance between the image sensor and the optical lens. However, a lens driving device such as a voice coil motor (VCM) has been recently developed to adjust the distance between the image sensor and the optical lens.

The voice coil motor includes a bobbin receiving a lens, a mover having a coil block wound around the bobbin, a stator driving the mover, an elastic member elastically supporting the mover, and a base supporting the mover and the stator, with an IR (Infrared) filter and an image sensor mounted on a rear of the base.

The conventional voice coil motor is problematic in that the mover reciprocates relative to the base to considerably deteriorate a quality of an image obtained from the image sensor when particles such as fine dust or foreign substances produced from the mover adhere to the IR filter secured to the base during a mover driving operation or a VCM assembling operation.

### BRIEF SUMMARY

Accordingly, the present invention provides a voice coil motor, configured to inhibit foreign substances coming from an outside or produced during an assembly process from being introduced into an IR filter.

Further, the present invention provides a voice coil motor, configured to inhibit contamination and defects from being caused by movement of a foreign-substance inflow inhibition film applied to a base having an IR filter so as to inhibit foreign substances from being introduced into the IR filter.

In one aspect of the present invention, there is provided a voice coil motor, the motor comprising: a base having an opening; a foreign-substance trapping film provided on an upper surface of the base to trap foreign substances; a mover disposed on the base and including a bobbin supporting a lens and a coil block provided on an outer circumference of the bobbin; a stator supported on the base and having a magnet disposed to face the coil block; and an elastic member connected to the mover and the base to elastically support the mover, wherein a receiving portion is formed on the upper surface of the base along a boundary of the foreign-substance trapping film.

In another aspect of the present invention, there is provided a voice coil motor, the motor comprising: a mover including a bobbin supporting a lens and a coil block provided on an outer circumference of the bobbin; a stator including a magnet disposed to face the coil block; a base supporting the mover and the stator and having an opening at a position corresponding to the lens; an elastic member including an elastic portion connected to the mover and the base to elastically support the mover; and a foreign-substance trapping film provided on an upper surface of the base and having viscosity to trap foreign substances, wherein a receiving groove is formed on the upper surface of the base to inhibit the foreign-substance trapping film from being introduced into at least one of the elastic portion and the opening of the base.

As apparent from the above description, a voice coil motor according to the present invention is advantageous in that it has a foreign-substance trapping film on an upper surface of a base to trap foreign substances, and inhibits the foreign-substance trapping film from being introduced into an elastic-member region and/or an opening in which an IR filter is installed, due to excessive application of the foreign-substance trapping film, thus inhibiting contamination from being caused by foreign substances and the foreign-substance trapping film.

### BRIEF DESCRIPTION OF THE DRAWINGS

FIG. 1 is an exploded perspective view showing a voice coil motor in accordance with an embodiment of the present invention;

FIG. 2 is a plan view showing a base of FIG. 1;

FIG. 3 is a sectional view taken along line I-I′ of FIG. 2;

FIG. 4 is a plan view showing a base of a voice coil motor in accordance with another embodiment of the present invention;

FIG. 5 is a plan view showing a base of a voice coil motor in accordance with another embodiment of the present invention;

FIG. 6 is a plan view showing a base of a voice coil motor in accordance with a further embodiment of the present invention; and

FIG. 7 is a plan view showing a base of a voice coil motor in accordance with a further embodiment of the present invention.

### DETAILED DESCRIPTION

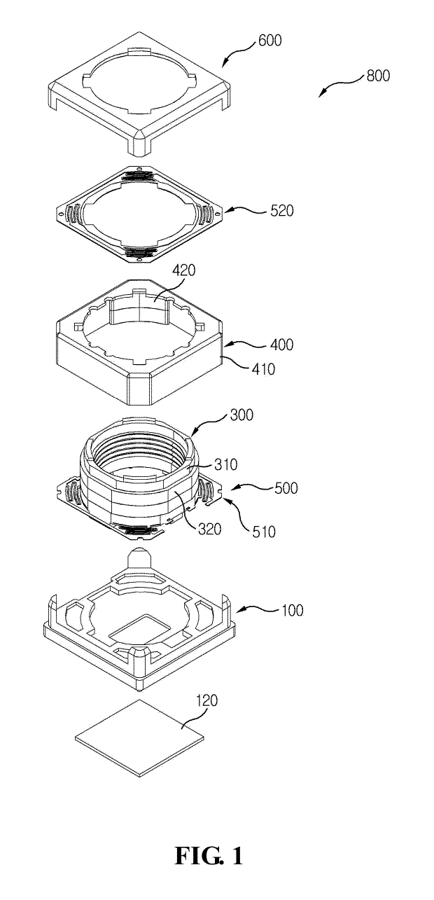

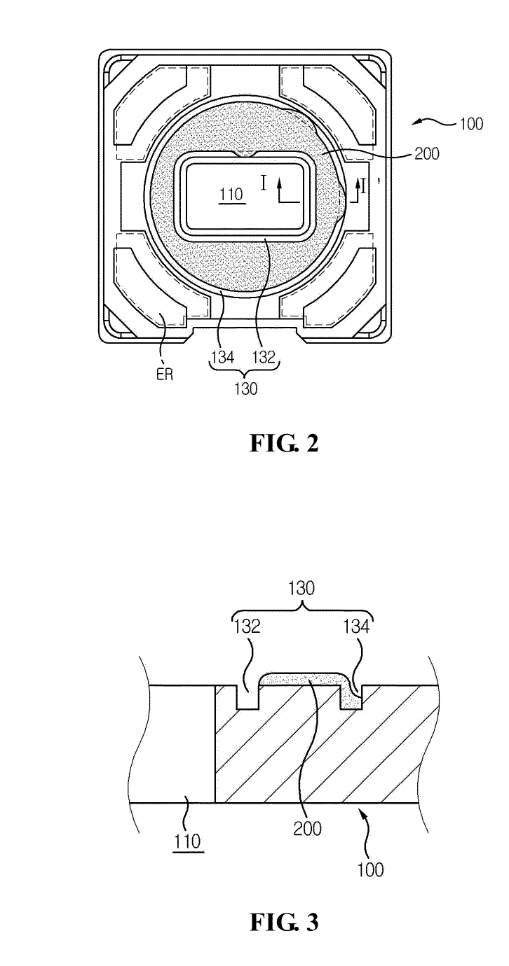

FIG. 1 is an exploded perspective view showing a voice coil motor in accordance with an embodiment of the present invention, FIG. 2 is a plan view showing a base of FIG. 1, and FIG. 3 is a sectional view taken along line I-I′ of FIG. 2.

Referring to FIGS. 1 to 3, a voice coil motor 800 includes a base 100, a foreign-substance trapping film 200, a mover 300, a stator 400 and an elastic member 500. In addition to the components, the voice coil motor 800 may include a cover member 600.

The base 100 takes a shape of a rectangular parallelepiped plate, with an opening 110 being formed in a central portion of the base 100. An IR filter 120 is disposed on a rear of the base 100 to correspond to the opening 110, and an image sensor (not shown) may be disposed on a rear of the IR filter 120.

Elastic-member regions ER are formed on an upper surface of the base 100 so that portions of the elastic member 500, which will be described below, are disposed thereon. The elastic-member regions ER are formed, respectively, on four corners of the upper surface of the base 100.

The foreign-substance trapping film 200 is formed on the upper surface of the base 100. The foreign-substance trapping film 200 traps foreign substances produced during the vertical movement of the mover 300 or the assembly of the voice coil motor 800, thus inhibiting the foreign substances from being introduced into the IR filter 120.

The foreign-substance trapping film 200 is formed thin by applying viscous liquid to the upper surface of the base 100. The foreign-substance trapping film 200 is formed on the upper surface of the base 100 except the elastic-member regions ER.

If an applied amount exceeds a predetermined amount when the viscous foreign-substance trapping film 200 is formed on the upper surface of the base 100, portion of the foreign-substance trapping film 200 may be introduced into the elastic-member regions ER. As such, when portion of the foreign-substance trapping film 200 is introduced into the elastic-member regions ER, the foreign-substance trapping film 200 is caught by portion of the elastic member 500 disposed on the elastic-member regions ER, thus considerably deteriorating a function of the elastic member 500.

Further, if an applied amount exceeds a predetermined level when the viscous foreign-substance trapping film 200 is formed on the upper surface of the base 100, the viscous foreign-substance trapping film 200 may be introduced into the IR filter 120 through the opening 110 of the base 100. As such, when portion of the foreign-substance trapping film 200 is introduced into the IR filter 120 through the opening 110, the IR filter 120 is contaminated, so that the quality of a digital image or a moving image formed from the image sensor is deteriorated.

According to an embodiment of the present invention, in order to inhibit the viscous foreign-substance trapping film 200 from being introduced into the opening 110 of the base 100 or the elastic-member regions ER, a receiving portion (or receiving groove) 130 is formed on the upper surface of the base 100 along a boundary of the foreign-substance trapping film 200.

In an embodiment of the present invention, the receiving portion 130 receives portion of the excessively applied foreign-substance trapping film 200, thus inhibiting the foreign-substance trapping film 200 from being introduced into the opening 110 of the base 100 and the elastic-member regions ER.

The receiving portion 130 includes a first receiving portion 132 and a second receiving portion 134.

The first receiving portion 132 is formed on the upper surface of the base 100, and is formed in a shape of a trench along the opening 110 of the base 100 that is an inner boundary of the foreign-substance trapping film 200. In an embodiment of the present invention, the first receiving portion 132 takes a shape of a closed loop when viewed on a plane.

A width and a depth of the first receiving portion 132 may be adjusted in consideration of an excessive application amount of the foreign-substance trapping film 200.

The second receiving portion 134 is formed on the upper surface of the base 100, and is formed in a shape of a trench along the elastic-member regions ER that are an outer boundary of the foreign-substance trapping film 200. In an embodiment of the present invention, the second receiving portion 134 takes a shape of a closed loop when viewed on a plane.

A width and a depth of the second receiving portion 134 may be adjusted in consideration of an excessive application amount of the foreign-substance trapping film 200.

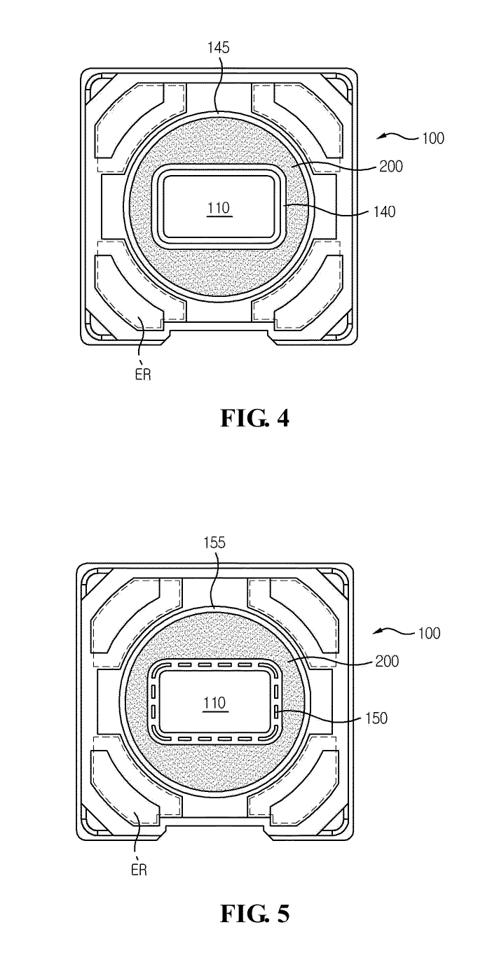

FIG. 4 is a plan view showing a base of a voice coil motor in accordance with another embodiment of the present invention.

Referring to FIGS. 1 and 4, a viscous foreign-substance trapping film 200 is formed on the upper surface of a base 100 having an opening 110. A receiving portion 140 having a shape of a trench may be formed around the opening 110 of the base 100 so as to inhibit an excessive applied portion of the foreign-substance trapping film 200 from being introduced into an IR filter 120 through the opening 110. When viewing the trench-shaped receiving portion 140 on a plane, the receiving portion 140 may take a shape of a closed loop.

Meanwhile, in order to inhibit the foreign-substance trapping film 200 from being introduced into elastic-member regions ER, an annular protrusion 145 may be provided between the elastic-member regions ER and the foreign-substance trapping film 200.

FIG. 5 is a plan view showing a base of a voice coil motor in accordance with another embodiment of the present invention.

Referring to FIGS. 1 and 5, a viscous foreign-substance trapping film 200 is formed on an upper surface of a base 100 having an opening 110. Further, in order to inhibit an excessive applied portion of the foreign-substance trapping film 200 from being introduced into an IR filter 120 through the opening 110, a trench-shaped receiving portion 150 is formed around the opening 110 of the base 100. When viewing the trench-shaped receiving portion 150 on a plane, the receiving portion 150 may comprise a plurality of receiving portions that are intermittently arranged.

Meanwhile, in order to inhibit the foreign-substance trapping film 200 from being introduced into the elastic-member regions ER, an annular protrusion 155 may be provided between the elastic-member regions ER and the foreign-substance trapping film 200.

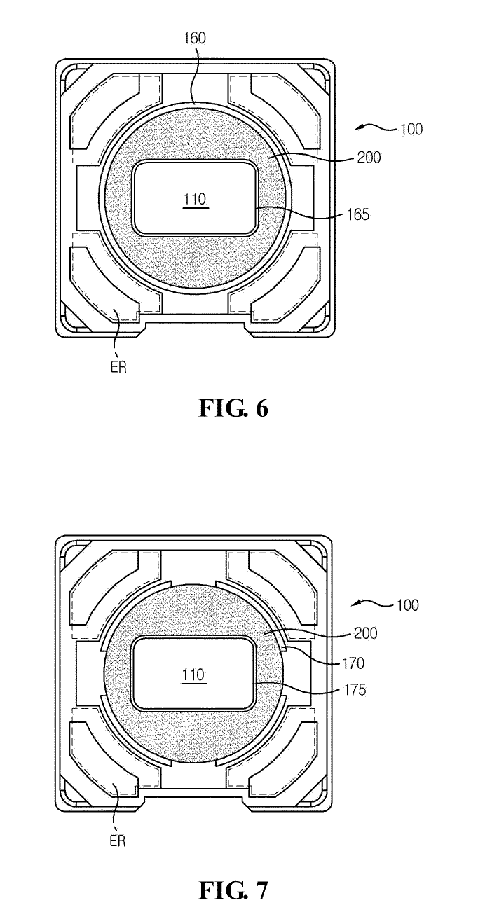

FIG. 6 is a plan view showing a base of a voice coil motor in accordance with a further embodiment of the present invention.

A viscous foreign-substance trapping film 200 is formed on an upper surface of a base 100 having an opening 110. Further, in order to inhibit an excessive applied portion of the foreign-substance trapping film 200 from being introduced into elastic-member regions ER, a trench-shaped receiving portion 160 is formed on the base 100 to be located between the elastic-member regions ER of the base 100 and the foreign-substance trapping film 200. When viewing the trench-shaped receiving portion 160 on a plane, the receiving portion 160 may take a shape of a closed loop.

Meanwhile, in order to inhibit the foreign-substance trapping film 200 from being introduced into the opening 110, an annular protrusion 165 may be provided along the opening 110.

FIG. 7 is a plan view showing a base of a voice coil motor in accordance with a further embodiment of the present invention.

A viscous foreign-substance trapping film 200 is formed on an upper surface of a base 100 having an opening 110. Further, in order to inhibit an excessive applied portion of the foreign-substance trapping film 200 from being introduced into elastic-member regions ER, a trench-shaped receiving portion 170 is formed on the base 100 to be located between the elastic-member regions ER of the base 100 and the foreign-substance trapping film 200. When viewing the trench-shaped receiving portion 170 on a plane, the receiving portion 170 may comprise a plurality of receiving portions 170 that are intermittently arranged. Particularly, the receiving portions 170 may be selectively formed at positions corresponding to the elastic-member regions ER.

Meanwhile, in order to inhibit the foreign-substance trapping film 200 from being introduced into the opening 110, an annular protrusion 175 may be provided along the opening 110.

Turning back to FIG. 1, the mover 300 includes a bobbin 310 receiving a lens, and a coil block 320 coupled to an outer circumference of the bobbin 310.

The bobbin 310 may take a cylindrical shape to receive the lens. The coil block 320 may be formed by directly winding long electric wire insulated by insulation resin around the outer circumference of the bobbin 310, or the coil block 320 may be wound and then coupled to the bobbin 310.

The stator 400 includes a yoke 410 and a magnet 420. The yoke 410 takes a shape of a square pillar, with the magnet 420 being disposed in the yoke 410. The magnet 420 is disposed to face the coil block 320 coupled to the outer circumference of the bobbin 310.

The elastic member 500 comprises a lower elastic member 510 and an upper elastic member 520.

The lower elastic member 510 comprises a pair of lower elastic members. Each lower elastic member 510 is coupled to a lower surface of the bobbin 310, and is electrically connected to both ends of the coil block 320.

Each lower elastic member 510 includes an elastic portion that generates elasticity in a zigzag mode. The elastic portion is disposed at a position corresponding to an associated elastic-member region ER of the base 100.

The upper elastic member 520 is disposed on the yoke 410, and is coupled to an upper end of the bobbin 310.

The cover member 600 is combined with the base 100, and presses the upper elastic member 520 to hold the upper elastic member 520 in place.

As described above, the present invention provides a voice coil motor, which has a foreign-substance trapping film on an upper surface of a base to trap foreign substances and inhibits the foreign-substance trapping film from being introduced into an elastic-member region and/or an opening in which an IR filter is installed, due to excessive application of the foreign-substance trapping film, thus inhibiting contamination from being caused by foreign substances and the foreign-substance trapping film.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A voice coil motor, comprising:
a base having an opening;
a foreign-substance trapping film provided on an upper surface of the base to trap foreign substances;
a mover disposed on the base, and including a bobbin supporting a lens and a coil block provided on an outer circumference of the bobbin;
a stator supported on the base, and having a magnet disposed to face the coil block; and
an elastic member connected to the mover and the base to elastically support the mover,
wherein a receiving portion is formed on the upper surface of the base along a boundary of the foreign-substance trapping film.

2. The voice coil motor as set forth in claim 1, wherein the receiving portion is formed around the opening of the base.

3. The voice coil motor as set forth in claim 2, wherein the receiving portion takes a shape of a closed loop along the opening of the base.

4. The voice coil motor as set forth in claim 2, wherein the receiving portion comprises a plurality of receiving portions intermittently formed along the opening of the base.

5. The voice coil motor as set forth in claim 1, wherein the receiving portion is formed on the upper surface of the base to be located between an elastic-member region corresponding to an elastic portion of the elastic member and the foreign-substance trapping film.

6. The voice coil motor as set forth in claim 5, wherein the elastic-member region is formed on each of four corners on the upper surface of the base, and the receiving portion takes a shape of a closed loop when viewed on a plane.

7. The voice coil motor as set forth in claim 5, wherein the receiving portion is selectively formed at a position corresponding to the elastic-member region.

8. The voice coil motor as set forth in claim 1, wherein the receiving portion includes:
a first receiving portion formed around the opening of the base; and
a second receiving portion formed on the upper surface of the base in such a way as to be spaced apart from the first receiving portion.

9. The voice coil motor as set forth in claim 1, wherein the receiving portion is concavely formed on the upper surface of the base.

10. The voice coil motor as set forth in claim 9, wherein the receiving portion takes a shape of a trench.

11. The voice coil motor as set forth in claim 1, wherein the foreign-substance trapping film includes epoxy resin having viscosity.

12. A voice coil motor, comprising:
a mover including a bobbin supporting a lens, and a coil block provided on an outer circumference of the bobbin;
a stator including a magnet disposed to face the coil block;
a base supporting the mover and the stator, and having an opening at a position corresponding to the lens;
an elastic member including an elastic portion connected to the mover and the base to elastically support the mover; and
a foreign-substance trapping film provided on an upper surface of the base and having viscosity to trap foreign substances,
wherein a receiving groove is formed on the upper surface of the base to inhibit the foreign-substance trapping film from being introduced into at least one of the elastic portion and the opening of the base.

13. The voice coil motor as set forth in claim 12, wherein the receiving groove is formed along a periphery of the opening in a shape of a trench.

14. The voice coil motor as set forth in claim 13, wherein the receiving groove takes a shape of a closed loop, when viewed on a plane.

15. The voice coil motor as set forth in claim 13, wherein the receiving groove comprises a plurality of receiving grooves formed intermittently, when viewed on a plane.

16. The voice coil motor as set forth in claim 12, wherein the receiving groove is formed between the elastic portion and the opening, and is formed along the elastic portion in a shape of a closed loop.

17. The voice coil motor as set forth in claim 12, wherein the receiving groove is formed between the elastic portion and the opening, and is formed at a position corresponding to the elastic portion.

18. The voice coil motor as set forth in claim 12, wherein the receiving groove includes:
a first receiving groove formed along a periphery of the opening in a shape of a trench, and
a second receiving groove formed along the elastic portion between the elastic portion and the opening.

19. The voice coil motor as set forth in claim 18, wherein each of the first and second receiving grooves takes a shape of a closed loop, when viewed on a plane.

20. The voice coil motor as set forth in claim 18, wherein each of the first and second receiving grooves is intermittently formed, when viewed on a plane.
